(19) United States
(12) Patent Application Publication
(10) Pub. No.: US 2026/0180309 A1
(43) Pub. Date: Jun. 25, 2026

(54) REACTION CIRCUIT TO A NEGATIVE VOLTAGE ON AN ELECTRIC LINE

(71) Applicant: STMicroelectronics International N. V., Geneva (CH)

(72) Inventors: Christophe Tourniol, Vif (FR); Nicolas Moeneclaey, Grenoble (FR)

(21) Appl. No.: 19/429,704

(22) Filed: Dec. 22, 2025

(30) Foreign Application Priority Data
Dec. 23, 2024 (FR) FR2415067

(51) Int. Cl. H02H 7/00

(52) U.S. Cl. CPC H02H 7/008

(57) ABSTRACT

According to an embodiment, an integrated circuit is proposed comprising a reaction circuit with negative medium voltage including a low-pass filter having an input coupled to an electrical line to be monitored, and an output configured to deliver a voltage corresponding to the medium voltage on the electrical line to be monitored; a transistor coupled to the low-pass filter is configured to receive the voltage of the signal traversing on the electrical line, the transistor being configured to be conducting when the voltage delivered by the low-pass filter is negative in such a way as to create a current path from a node of the integrated circuit to the electrical line.

### CROSS-REFERENCE TO RELATED APPLICATION

This application claims the benefit of French Patent Application No. 2415067, filed on December 23, 2024, which application is hereby incorporated by reference herein in its entirety.

### TECHNICAL FIELD

The present disclosure generally relates to integrated circuits and, in particular embodiments, to an integrated circuit that uses an electrical line for communication.

### BACKGROUND

There are many applications in which an electrical line is subjected to a positive voltage, particularly for communicating data between two electronic devices. In these applications, an undesirable negative medium voltage (i.e., the direct current (DC) component of the voltage on the electrical line) may occur under certain conditions.

There are many applications in which an electrical line is subjected to a positive voltage, particularly for communicating data between two electronic devices. In these applications, an undesirable negative medium voltage (i.e., the DC component of the voltage on the electrical line) may occur under certain conditions.

It is then important to propose a solution that allows limiting the appearance of such an undesired negative medium voltage. Tests may be provided to verify the circuit’s condition when subjected to these conditions.

For example, the Local Interconnect Network (LIN) protocol is a communication protocol used in the automotive industry for non-critical functions. The LIN protocol is often used for applications such as window control, door locks, mirrors, and climate control. It operates under a master-slave architecture, in which a single master communicates with a plurality of slaves. The LIN protocol uses a single-wire communication bus to couple the devices in the LIN network.

The LIN protocol is subject to various certifications, particularly to ensure electromagnetic compatibility (EMC) and radio frequency (RF) interference immunity, as specified by SAE J2962-1. These certifications are essential to ensuring the reliability and security of vehicle communications. In particular, the SAE J2962-1 standard imposes a Bulk Current Injection (BCI) radio-frequency immunity test.

This test assesses the system’s ability to withstand electromagnetic disturbances by injecting an RF current into the communication bus. The BCI test verifies that the bus can maintain acceptable voltage levels even under the influence of strong RF signals. More particularly, the test ensures that the medium-voltage in the bus’s dominant mode does not fall below -5 V. Therefore, a solution should be proposed to prevent the LIN communication bus voltage from falling below -5 V.

Moreover, there are transient immunity tests on an electrical line, such as a LIN communication bus. These transient immunity tests may result in negative medium voltages that should be avoided on the electrical line. Thus, a solution should be proposed to avoid negative medium voltages on an electrical line during transient immunity tests.

### SUMMARY

Technical advantages are generally achieved by embodiments of this disclosure, which describe an integrated circuit that uses an electrical line for communication.

According to one aspect, an integrated circuit is proposed comprising a reaction circuit with a negative medium voltage including a low-pass filter having an input coupled to an electrical line to be monitored, and an output configured to deliver a voltage corresponding to the medium voltage (i.e., the direct current component (DC) of the voltage) on the electrical line to be monitored, a transistor coupled to the low-pass filter configured to receive the voltage of the signal traversing on the electrical line, the transistor being configured to be conducting when the voltage delivered by the low-pass filter is negative, particularly less than a voltage opposite the threshold voltage of the transistor of the reaction circuit, in such a way as to create a current path from a node of the integrated circuit to the electrical line.

Such a reaction circuit allows limiting the occurrence of negative medium voltage on the electrical line, particularly its impact on the electrical line’s operation, by creating a current path between the integrated circuit node and the electrical line.

In an advantageous embodiment, disturbances may be injected into the electrical line to be monitored, the low-pass filter of the reaction circuit being configured to filter these disturbances. Preferably, the transistor in the reaction circuit is a metal-oxide gate field-effect transistor, particularly a high-voltage type, capable of withstanding stresses that may be present on the electrical line, for example, a drain-source voltage up to 50 Volts. Advantageously, the transistor in the reaction circuit has a source coupled to the low-pass filter output, a drain coupled to the node through which a current path is created, and a gate coupled to ground.

Advantageously, the transistor of the reaction circuit is configured to draw a current from the node from which the current path is created when the gate-source voltage of the transistor of the reaction circuit is greater than a threshold voltage of this transistor. Such a gate-source voltage is obtained when the medium voltage on the electrical line is negative.

In an advantageous embodiment, the reaction circuit includes a first diode having a cathode coupled to the drain of the transistor of the reaction circuit and a configured anode coupled to the node from which a current path is created.

Preferably, the reaction circuit includes a second diode having a cathode coupled to the gate of the transistor of the reaction circuit and an anode coupled to a ground. This second diode prevents current from being injected into ground. The second diode can also meet certain normative tests. Advantageously, the reaction circuit comprises a resistive element (i.e., resistance) between the gate and the source of the transistor of the reaction circuit. In an advantageous embodiment, the electrical line to be monitored is a LIN bus.

In one embodiment, the integrated circuit further comprises a main transistor configured to control the LIN bus, the main transistor having a drain coupled to the LIN bus via a diode, a source coupled to a ground, and a gate configured to receive a control signal, the transistor of the reaction circuit having a drain coupled to the gate of the main transistor.

In this embodiment, the reaction circuit creates a current path between the main transistor’s gate and the LIN bus when the average voltage on the LIN bus is negative and the LIN bus is in a dominant operating mode, enabling the main transistor to conduct. This allows the voltage on the LIN bus to be relayed. The reaction circuit thus allows limiting the occurrence of negative medium voltage on the LIN bus when it is in a dominant operating mode.

Advantageously, the drain of the transistor in the reaction circuit is coupled to the gate of the main transistor via the first diode. This first diode makes it possible to avoid injecting current into the control of the main transistor when the LIN bus is in a recessive operating mode.

Furthermore, the second diode prevents current from being injected into ground when the LIN bus is in a recessive operating mode.

In one embodiment, the drain of the transistor of the reaction circuit is coupled, particularly via the first diode, to an output of at least one circuit for protecting against electrostatic discharges and to a node between a main transistor for controlling the electrical line, for example a LIN bus, and a diode via which the drain of the main transistor is coupled to the electrical line.

In such an embodiment, when the at least one discharge protection circuit is not triggered and when the electrical line has been previously put into a positive voltage (for example when the electrical line is in a recessive state or after a positive pulse injected during a transient disturbance immunity test), the node coupled to the output of the at least one protection circuit becomes floating, as well as the node between the drain of the main transistor and the diode coupling the main transistor to the electrical line. The reaction circuit then allows a current path to be established between these nodes and the electrical line.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an integrated circuit including a reaction circuit configured to monitor an electrical line;

FIG. 2 is a block diagram of a reaction circuit;

FIG. 3 is a block diagram of an integrated circuit wherein the electrical line to be monitored is a LIN bus; and

FIG. 4 is a block diagram of a reaction circuit that provides transient-pulse immunity in an integrated circuit.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

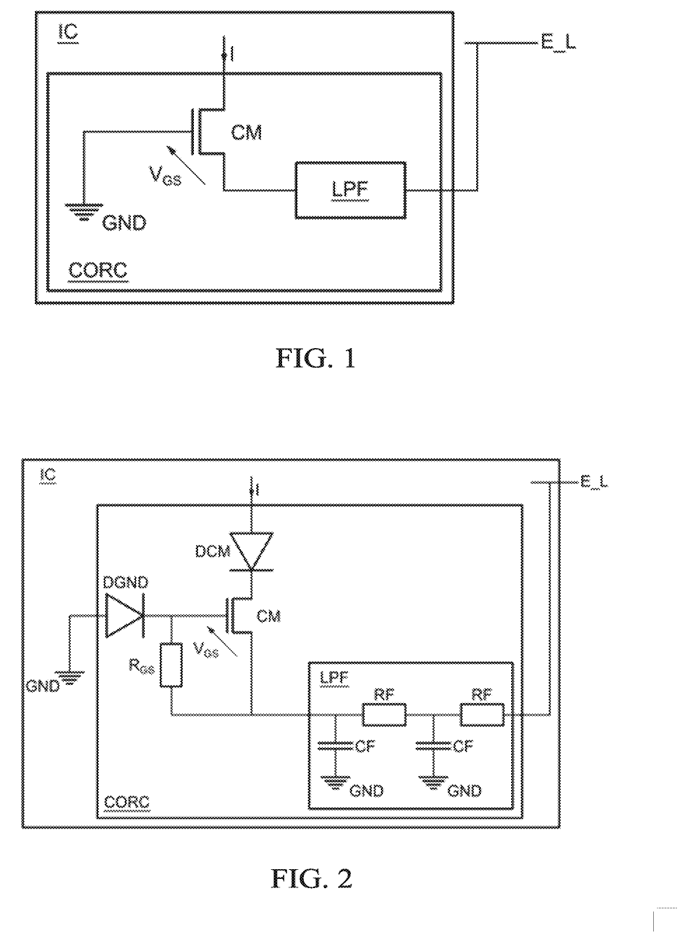

FIG. 1 illustrates an integrated circuit (IC) including a reaction circuit (CORC) configured to monitor an electrical line (E_L).

The electrical line (E_L) is configured to transport an electrical signal having a positive or zero voltage in normal operation. The electrical line (E_L) may be subjected to disturbances that may impact the voltage on the electrical line (E_L).

For example, there are tests such as Bulk Current Injection (BCI) radio frequency interference immunity tests or transient pulse immunity tests, during which disturbances can be injected into the electrical line to assess the integrated circuit (IC) ‘s behavior against them.

The reaction circuit (CORC) is coupled, on the one hand, to the electrical line (E_L) to be monitored, and, on the other hand, to a node of the integrated circuit. The reaction circuit (CORC) is configured to create a current path between the node and the electrical line (E_L) to be monitored when the medium voltage (i.e., the direct component (DC) of the voltage) on this electrical line (E_L) is negative, particularly less than a negative threshold.

The reaction circuit (CORC) consists of a low-pass filter (LPF) and a CM transistor. The low-pass filter (LPF) has an input coupled to the electrical line (E_L) and an output coupled to the CM transistor.

The low-pass filter (LPF) is configured to filter disturbances injected into the electrical line (E_L) to be monitored, delivering as output the medium voltage on the electrical line (E_L).

The CM transistor is an insulated-gate field-effect transistor (FET) (also referred to as a Metal-Oxide-Semiconductor (MOS) FET (MOSFET)), particularly a high-voltage device capable of withstanding stresses that may be present on the electrical line, for example, a drain-source voltage up to 50 Volts. In particular, the CM transistor may be an NMOS transistor, having a channel of type n.

The CM transistor has its source coupled to the low-pass filter (LPF) output. The CM transistor has a drain configured to be coupled to a node of the integrated circuit (IC) from which a current path is created when the medium voltage on the electrical line is negative, in particular, less than a negative threshold, for example, less than the opposite value of a threshold voltage of the CM transistor. The CM transistor also has a gate coupled to a ground GND.

The CM transistor is configured to draw a current I when the gate-source voltage VGS of the CM transistor is greater than a threshold voltage VT of this transistor. Such a gate-source voltage VGS is obtained when the medium voltage on the electrical line (E_L) is negative. This makes it possible to create a current path I between the node to which the drain of the CM transistor is coupled and the electrical line (E_L).

FIG. 2 illustrates an advantageous embodiment of a reaction circuit (CORC). In this embodiment, the low-pass filter (LPF) is a second-order low-pass filter comprising two cells RC in cascade. Each cell includes a resistive element RF and a capacitive element CF. The resistive element RF is placed in series with respect to the input of the low-pass filter (LPF) and the capacitive element CF is placed in parallel with respect to the output of the low-pass filter (LPF). Alternatively, it is possible to use a low-pass filter having a single cell RC.

Furthermore, the reaction circuit (CORC) includes a resistance RGS between the CM transistor’s drain and source. This resistance RGS prevents the CM transistor from remaining conducting due to storage in the capacity CGS (not shown) between the gate and the source of the CM transistor when the medium voltage on the electrical line (E_L) becomes positive again, because the diode DGND is blocked. The resistor RGS makes it possible to discharge the capacity CGS so that the voltage VGS of the CM transistor becomes zero again

The value of the capacitive elements CF and the resistive elements RF of the low-pass filter (LPF), as well as the value of the resistance RGS between the source and the gate of the transistor, make it possible to adjust the discharge of the electrical line (E_L), the filtering effect of the low-pass filter (LPF), and the reaction time of the circuit CORC.

Furthermore, in this embodiment, the reaction circuit (CORC) also comprises a diode DCM coupled to the drain of the CM transistor and configured to receive the current I. In particular, the diode DCM has a cathode coupled to the CM transistor’s drain and an anode configured to receive current I. This diode DCM protects the voltage at the source of the current I against negative medium voltage that may appear on the electrical line (E_L).

The reaction circuit (CORC) also includes a diode DGND between the ground GND and the CM transistor gate. This diode DGND has an anode coupled to the ground and a cathode coupled to the CM transistor grid. This diode DGND prevents a direct resistive impedance between the electrical line (E_L) to be monitored and the ground GND.

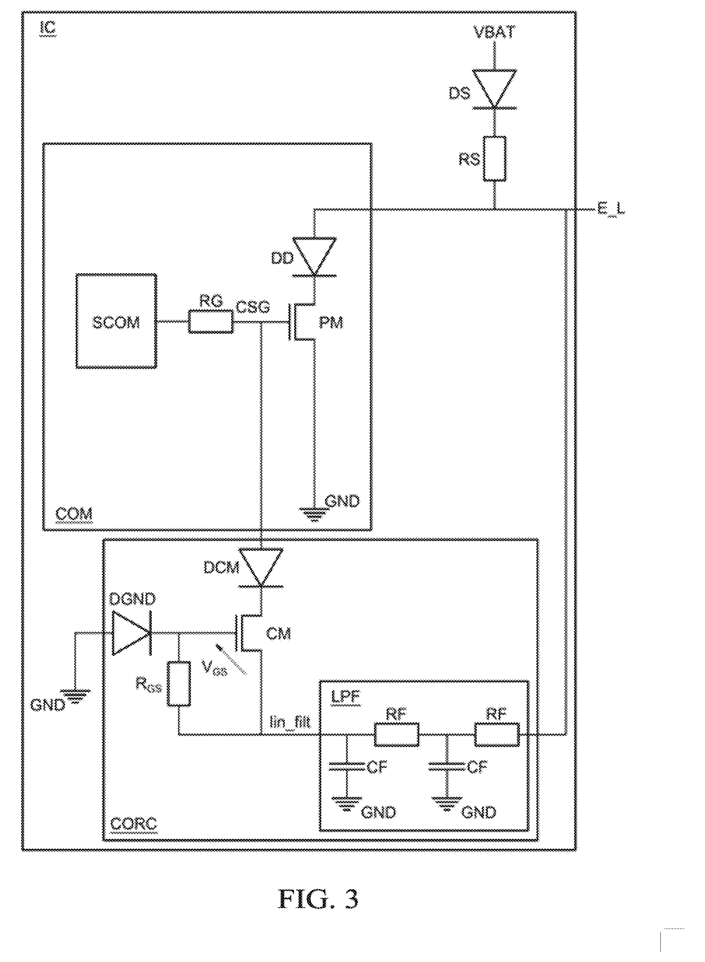

FIG. 3 illustrates one embodiment of an integrated circuit (IC) wherein the electrical line (E_L) to be monitored is a Local Interconnect Network (LIN) bus. The integrated circuit (IC) has a circuit COM for controlling the LIN bus. The circuit COM for controlling the LIN bus is the transmitter’s output stage.

The circuit COM for controlling the LIN bus includes a main PM transistor associated with the LIN bus. The main PM transistor is a MOSFET transistor. The main PM transistor may, for example, be an NMOS transistor. The main PM transistor has a drain coupled to the LIN bus via a diode DD. In particular, the cathode of the diode DD is coupled to the drain of the NMOS transistor, and the anode of the diode DD is coupled to the LIN bus.

The circuit COM for controlling the LIN bus also has a resistor RG.

The circuit COM for controlling the LIN bus further includes a control signal generator circuit SCOM configured to generate a control signal for controlling the main PM transistor.

In particular, the control signal upstream of the resistor RG is configured to present a voltage V1, enabling the main PM transistor to be placed in dominant mode, and to present a 0-volt voltage, enabling the non-conducting PM transistor to be placed in recessive mode.

The LIN bus is supplied by a power source VBAT. In particular, the LIN bus is coupled to the power source VBAT via a pull-up resistor RS and a diode DS mounted in series. In particular, the diode DS has an anode coupled to the power source VBAT, and a cathode coupled to a first terminal of the pull-up resistor RS. The pull-up resistor RS has a second terminal coupled to the LIN bus.

The LIN bus may be subject to disturbances, particularly during BCI radio-frequency interference immunity tests. As explained previously, these disturbances may lead to a negative medium voltage on the LIN bus, particularly when the LIN bus is in a dominant mode.

To limit the impact of such disturbances, the reaction circuit (CORC) is coupled to the LIN bus to monitor it and adapt LIN bus control when a negative medium voltage is detected.

As described previously, the reaction circuit (CORC) comprises a low-pass filter (LPF) and a CM transistor, such as a MOSFET. The low-pass filter (LPF) has an input coupled to the LIN bus and an output coupled to the CM transistor.

The CM transistor has a drain coupled to the gate of the main PM transistor, a source coupled to the output of the low-pass filter (LPF), and a gate coupled to the ground GND.

Preferably, the drain of the CM transistor is coupled to the gate of the main PM transistor via a diode DCM, and the gate of the CM transistor is coupled to the ground via a diode DGND, as described in FIG. 2. The diode DCM is then used to protect the gate of the main PM transistor from the voltage that may appear on the LIN bus. The diode DGND prevents a direct resistive impedance between the LIN bus and ground GND. The diode DGND prevents current from being injected into ground.

The reaction circuit (CORC) is used to limit the impact of electromagnetic disturbances on the LIN bus, particularly during radio frequency interference immunity tests.

In particular, the reaction circuit (CORC) makes it possible to lower the gate voltage of the main PM transistor of the control circuit (COM) when the medium voltage on the LIN bus is negative, particularly when the medium voltage on the LIN bus is less than the opposite value of the threshold voltage of the CM transistor (i.e., VLIN_DC <-VT). Indeed, when the CM transistor is conducting, a reaction current is drawn from the gate of the main PM transistor.

The reaction circuit (CORC) therefore makes it possible to change the behavior of the control circuit (COM) when the medium voltage on the LIN bus is negative and the LIN bus is in a dominant mode due to the action of the control circuit (COM) making the main PM transistor conducting, particularly so that the medium voltage on the LIN bus remains in a range compliant with the standard SAE J2962-1 (greater than -5 Volts).

Such a reaction circuit (CORC) has no impact on the LIN bus’s performance. Furthermore, such a reaction circuit (CORC) is simple, takes up little space in the integrated circuit (IC) and requires no additional energy consumption. Furthermore, such a circuit CORC complies with other standard tests, such as leakage current tests in the event of ground or battery loss.

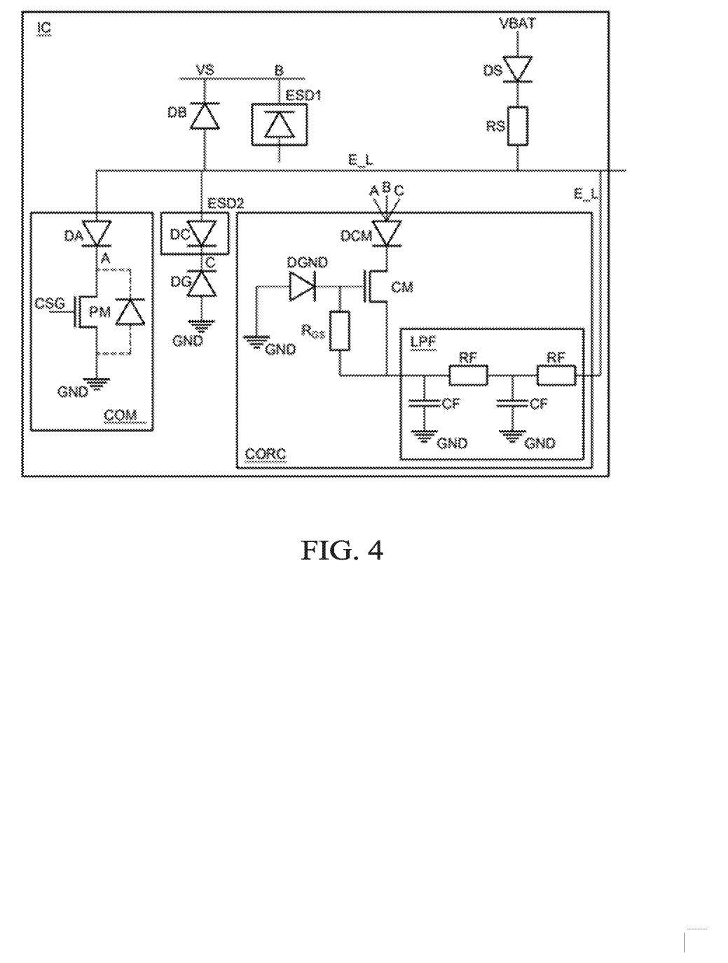

FIG. 4 illustrates another embodiment wherein the reaction circuit (CORC) is used to provide a transient pulse immunity in an integrated circuit (IC). In particular, the integrated circuit (IC) comprises an electrical line (E_L) to be monitored. This electrical line (E_L) may be a LIN bus, for example.

The electrical line (E_L) is supplied by a power source VBAT. In particular, the electrical line (E_L) is coupled to the power source VBAT via a diode DS and a resistor RS mounted in series. The diode DS has an anode coupled to the power source VBAT and a cathode coupled to a first terminal of the resistor RS. The resistor RS has a second terminal coupled to the electrical line (E_L).

The integrated circuit (IC) also has a control circuit (COM) for controlling the electrical line (E_L).

In particular, the control circuit (COM) includes a PM transistor, enabling control of the electrical line (E_L). The PM transistor is a MOSFET-type transistor, for example, an NMOS transistor.

This PM transistor has a gate configured to receive a control signal (CSG), a source coupled to the ground GND and a drain coupled to the electrical line (E_L) via a diode DA of the control circuit (COM). This diode DA has a cathode coupled to the PT transistor’s drain and an anode coupled to the electrical line (E_L). Node A is defined between the PT transistor and diode DA.

The integrated circuit (IC) also comprises a diode DB between a voltage source (VS) and the electrical line (E_L). This diode DB has a cathode coupled to the voltage source by a node B and an anode coupled to the electrical line (E_L). The voltage source (VS) provides a positive floating rail to protect against electrostatic discharges.

The integrated circuit comprises various circuits ESD1 and ESD2 for protecting against electrostatic discharges. These protection circuits may be based on a Darlington configuration.

In particular, a first circuit ESD1 is disposed between the voltage source (VS) and ground GND to protect against electrostatic discharges. This first protection circuit ESD1 is equivalent to a diode when the first protection circuit ESD1 is not tripped.

This diode has a cathode coupled to the voltage source (VS) and an anode coupled to the ground GND. Node B is defined between the first protection circuit ESD1, which protects against discharges, and the voltage source (VS). When the first protection circuit ESD1 is not tripped, it behaves as a diode, making node B floating.

A second circuit ESD2 for protecting against electrostatic discharges is disposed between the LIN bus and the ground GND. In particular, this second protection circuit ESD2 is equivalent to a diode DC when the second protection circuit is not triggered. This diode DC has an anode coupled to the LIN bus and a cathode coupled to the ground via a diode DG.

This diode DG has a cathode coupled to the cathode of the second circuit ESD2 to protect against electrostatic discharges, and an anode coupled to ground. Node C is defined between the second circuit ESD2, which protects against electrostatic discharges, and the diode DG. When the second protection circuit ESD2 is not tripped, it behaves as a diode, making the node C floating.

In the context of transient disturbance immunity tests, disturbances are injected into the electrical line (E_L). These disturbances correspond to pulses injected into the electrical line (E_L). These pulses may lead to a negative medium voltage on the electrical line (E_L). Furthermore, these pulses are not fast enough to trigger the protection circuits ESD1, ESD2. Thus, the nodes A, B, and C float when these pulses are injected into the electrical line (E_L).

In particular, the nodes A, B, and C float when the electrical line (E_L) has been previously set to a positive voltage (for example, at a recessive level or after a positive pulse injected during a transient disturbance immunity test). More particularly, firstly, the nodes A, B, and C follow the voltage on the electrical line (E_L) through the diode. When the signal on the electrical line (E_L) drops again, the diodes DA, DB, and DC are in the inverse state, and the nodes A, B, and C are floating. Depending on the positive pulse injected during a transient disturbance immunity test, the medium voltage of the electrical line (E_L) may subsequently drop to a negative value. If this medium voltage becomes too negative, as the nodes A, B, and C remain charged at a high value, the diodes DA, DB, and DC may inversely be subjected to a voltage higher than the maximum conditions that can be supported by these diodes (these conditions can be referred to as AMR for Absolute Maximum Rating).

It is then advisable to prevent reverse voltage on the diodes DA, DB, and DC from exceeding the maximum ratings of these diodes. These maximum conditions are not reached when the medium voltage on the electrical line does not fall below a negative threshold.

The reaction circuit (CORC) provides a discharge path through nodes A, B, and C when the medium voltage on the electrical line (E_L) becomes negative. The reaction circuit (CORC) prevents the medium voltage on the electrical line from falling below the negative voltage threshold.

More particularly, the reaction circuit (CORC) includes a CM transistor and a diode DCM for each node A, B, and C. Each diode DCM has a cathode coupled to the CM transistor’s drain and an anode coupled to the nodes A, B, or C.

Such a reaction circuit (CORC) makes it possible to create an effective discharge path on the nodes A, B, and C when the voltage of the electrical line becomes negative, particularly when the voltage of the electrical line becomes less than the opposite of the threshold voltage of the CM transistor of the reaction circuit (CORC).

Such a reaction circuit (CORC) enables reducing the risk of exceeding an absolute maximum rating during transient immunity tests.

As previously noted, such a reaction circuit (CORC) is simple, occupies little space in the integrated circuit (IC), and requires no additional energy.

Of course, the reaction circuit (CORC) may be used in other applications requiring monitoring a negative medium voltage on an electrical line, to create a current path from a node of the integrated circuit to the electrical line when the medium voltage on the electrical line is negative, particularly less than a negative threshold.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. An integrated circuit comprising a reaction circuit with a negative medium voltage, the reaction circuit comprising:
a low-pass filter having an input coupled to an electrical line to be monitored and an output configured to deliver a voltage corresponding to a medium voltage on the electrical line; and
a transistor coupled to the low-pass filter configured to receive the voltage traversing on the electrical line, the transistor configured to conduct in response to the voltage from the low-pass filter being negative such that it creates a current path from a node of the integrated circuit to the electrical line.

2. The integrated circuit of claim 1, wherein the low-pass filter is configured to filter disturbances injected into the electrical line.

3. The integrated circuit of claim 1, wherein the transistor is a metal-oxide gate field effect transistor (FET).

4. The integrated circuit of claim 1, wherein the transistor has a source terminal coupled to the output of the low-pass filter, a drain terminal coupled to the node, and a gate terminal coupled to ground.

5. The integrated circuit of claim 4, wherein the reaction circuit comprises a first diode having a cathode terminal coupled to the drain terminal of the transistor and an anode terminal coupled to the node.

6. The integrated circuit of claim 5, wherein the reaction circuit comprises a second diode having a cathode terminal coupled to the gate terminal of the transistor and an anode terminal coupled to ground.

7. The integrated circuit of claim 4, wherein the reaction circuit comprises a resistance between the gate terminal of the transistor and the source terminal of the transistor.

8. The integrated circuit of claim 1, wherein the electrical line is a Local Interconnect Network (LIN) bus.

9. The integrated circuit of claim 8, wherein the transistor is a first transistor, the integrated circuit further comprising a second transistor configured to control the LIN bus, the second transistor having a drain terminal coupled to the LIN bus via a first diode, a source terminal coupled to ground, and a gate terminal configured to receive a control signal, wherein the first transistor has a drain terminal coupled to the gate terminal of the second transistor.

10. The integrated circuit of claim 9, wherein the node is a first node, and wherein the drain terminal of the first transistor is coupled via the first diode to an output of at least one electrostatic discharge protection circuit and to a second node between the second transistor and a second diode coupling the drain terminal of the second transistor to the electrical line.

11. A method of protecting an electrical line from negative medium voltage in an integrated circuit, the method comprising:
filtering, via a low-pass filter, a signal on the electrical line to be monitored to obtain a medium voltage on the electrical line;
receiving, at a transistor coupled to an output of the low-pass filter, a voltage traversing on the electrical line;
conducting, via the transistor, in response to the voltage from the low-pass filter being negative; and
creating a current path from a node of the integrated circuit to the electrical line in response to the transistor conducting.

12. The method of claim 11, further comprising filtering, via the low-pass filter, disturbances injected into the electrical line.

13. The method of claim 11, wherein the transistor is a metal-oxide gate field effect transistor (FET), and wherein conducting via the transistor comprises:
receiving the voltage from the low-pass filter at a source terminal of the transistor;
coupling a drain terminal of the transistor to the node; and
coupling a gate terminal of the transistor to ground.

14. The method of claim 11, wherein the electrical line is a Local Interconnect Network (LIN) bus, the method further comprising:
controlling the LIN bus via a second transistor having a drain terminal coupled to the LIN bus via a first diode, a source terminal coupled to ground, and a gate terminal configured to receive a control signal; and
coupling a drain terminal of the transistor to the gate terminal of the second transistor to modify control of the LIN bus when the medium voltage on the LIN bus is negative.

15. The method of claim 14, wherein the node is a first node, the method further comprising:
coupling the drain terminal of the transistor via the first diode to an output of at least one electrostatic discharge protection circuit; and
coupling the drain terminal of the transistor to a second node between the second transistor and a second diode, wherein the second diode couples the drain terminal of the second transistor to the electrical line.

16. A reaction circuit for limiting negative medium voltage on an electrical line, the reaction circuit comprising:
a low-pass filter having:
an input configured to couple to an electrical line to be monitored, and
an output configured to deliver a voltage corresponding to a medium voltage on the electrical line; and
a transistor having:
a source terminal coupled to the output of the low-pass filter,
a drain terminal configured to couple to a node of an integrated circuit, and
a gate terminal coupled to ground,
wherein the transistor is configured to conduct when the voltage from the low-pass filter is negative to create a current path from the node to the electrical line.

17. The reaction circuit of claim 16, wherein the low-pass filter is configured to filter disturbances on the electrical line.

18. The reaction circuit of claim 16, further comprising a resistance coupled between the gate terminal and the source terminal of the transistor.

19. The reaction circuit of claim 16, further comprising a first diode having a cathode terminal coupled to the drain terminal of the transistor and an anode terminal configured to couple to the node.

20. The reaction circuit of claim 19, further comprising a second diode having a cathode terminal coupled to the gate terminal of the transistor and an anode terminal coupled to ground.
